(19) United States
(12) Patent Application Publication
(10) Pub. No.: US 2013/0250310 A1
(43) Pub. Date: Sep. 26, 2013

(54) Position Recognition

(71) Applicants: Markus Gerigk, Koeln (DE); Andreas Baecker, Wuppertal (DE); Simon Hoff, Pulheim (DE); Thomas Birsztejn, Dormagen (DE); Christian Roth, Leverkusen (DE); Stephan Tabaschuss, Koeln (DE); Walter Speth, Dueren (DE); Ralf Imhaeuser, Langenfeld (DE)

(72) Inventors: Markus Gerigk, Koeln (DE); Andreas Baecker, Wuppertal (DE); Simon Hoff, Pulheim (DE); Thomas Birsztejn, Dormagen (DE); Christian Roth, Leverkusen (DE); Stephan Tabaschuss, Koeln (DE); Walter Speth, Dueren (DE); Ralf Imhaeuser, Langenfeld (DE)

(73) Assignee: BAYER INTELLECTUAL PROPERTY GMBH, Monheim (DE)

(21) Appl. No.: 13/990,758

(22) PCT Filed: Dec. 8, 2011
(86) PCT No.: PCT/EP2011/072171

§ 371 Date: May 30, 2013

(30) Foreign Application Priority Data
Dec. 13, 2010 (DE) 102010062959.6

(51) Int. Cl. G01B 11/14

(52) U.S. Cl. CPC G01B 11/14
USPC 356/614

(57) ABSTRACT

The present invention relates to a method for registering an object and for finding again a section of the object.

The present invention relates to a method for registering an object and for finding again a section of the object.

Automation during the production and processing of many industrial goods and products necessitates automated recognition and finding again of objects and/or sections of objects.

The published Patent Application DE3704313A1 is concerned, for example, with a contactless optical method for recognizing an object. A hologram is applied to the object. The hologram is illuminated with coherent light and the radiation returned from the hologram is captured with the aid of a camera. Conclusions about the type of object, its position spatially, changes in form and dynamic behaviour can be drawn from the returned radiation.

What is disadvantageous about the method is the need for an aid (hologram) which has to be applied to the object. Consequently, the method cannot be used for objects which cannot be provided with corresponding aids. Moreover, an object would have to be provided with a multiplicity of holograms in order to be able to recognize and find again different sections of the object.

During the production of films and coatings, for example inclusions of impurities or generally defects can occur which have to be identified and, if appropriate, eliminated prior to further processing. In many processes, it is not possible for defects which can occur in the course of a processing step to be marked during said processing step.

Therefore, the present invention addresses the problem of recognizing and/or finding again a section of an object, without the section having to be provided with a marking. The method sought is intended to be performed contactlessly, to make possible a high speed during recognition and/or finding again, and to be simple in operation and need little maintenance.

This problem is solved by means of the methods according to independent Claims 1, 2 and 3. Preferred embodiments are found in the dependent claims.

The present invention is based on the finding that the intrinsic structural properties of objects, in particular the surface structure of an object, yield features for unambiguous recognition and/or finding again of sections of the object. In this case, however, it would be too complicated to detect the complete intrinsic structural properties of an object by means of image processing systems and to store them in a database in order to be able to find specific sections again at a later point in time.

It has surprisingly been found that the scanning of an object with electromagnetic radiation having a linear beam profile simply and rapidly yields enough information to find individual sections of the object again with high accuracy and likewise rapidly.

Therefore, first subject matter of the present invention is a method for registering an object, characterized in that a region of the object is scanned with electromagnetic radiation and at least part of the electromagnetic radiation emitted from the object on account of the scanning is captured and the scanning signal obtained, if appropriate after signal processing, is stored together with further parameters concerning individual sections of the object in the form of a reference profile in a database, wherein the electromagnetic radiation used for scanning has a linear beam profile.

Further subject matter of the present invention is a method for recognizing and/or finding again a section of an object, comprising the following steps:
determining, on the basis of the reference profile with respect to the object, in which section of the object a predefined parameter is present,
scanning the determined section with electromagnetic radiation, capturing at least part of the electromagnetic radiation emitted from the object on account of the scanning, and generating a local profile from the scanning signal obtained, if appropriate using signal processing methods, wherein the electromagnetic radiation used for scanning has a linear beam profile,
comparing the local profile with that part of the reference profile which corresponds to the determined section.

Further subject matter of the present invention is a method for assigning a section of a processed object to the corresponding section of the unprocessed object, comprising the following steps:
scanning a section of the processed object with electromagnetic radiation, capturing at least part of the electromagnetic radiation emitted from the processed object on account of the scanning, and generating a local profile from the scanning signal obtained, if appropriate using signal processing methods, wherein the electromagnetic radiation used for scanning has a linear beam profile,
comparing, section by section, the local profile with the reference profile of the unprocessed object and identifying that section of the reference profile which has the greatest similarity to the local profile.

The present invention can formally be subdivided into two phases. In a first phase—also called the first phase hereinafter—an object is registered. In the course of this registration, a reference profile is generated, which is stored in a database. The reference profile contains information concerning intrinsic structural properties of the object and the positions of the object at which the intrinsic structural properties occur.

The reference profile thus represents as it were a kind of map of the object, on which information about intrinsic structural properties are noted as a function of location.

Furthermore, the reference profile contains parameters concerning individual sections of the object. Said parameters together with the information concerning the intrinsic structural properties of the object are noted in the reference profile. That means that the reference profile, with respect to individual sections identified by one or more parameters, contains information about the intrinsic structural properties of the object in said sections.

To continue the metaphor of the map used above, the parameters identify specific features on the map, such as lighthouses, for example.

In a later second phase of the present invention—also designated as the second phase hereinafter—a section of the object is recognized and/or found again.

Before the invention is explained in greater detail on the basis of preferred embodiments, specific application possibilities for the invention will be presented in order to make the terms used above clearer.

One conceivable application possibility is, for example, finding defects again. It is conceivable for defects such as, for example, scratches or inclusions to occur during the production and processing of an object. Furthermore, it is conceivable that these defects cannot be immediately eliminated, for example because immediate elimination would mean interrupting the production or processing methods. With the aid of the present invention, said defects are firstly detected. The object is scanned by means of electromagnetic radiation in order to generate a characteristic scanning signal, which is characteristic of individual sections of the object such that said sections can unambiguously be found again later. A reference profile is generated from the scanning signal. Details regarding locations at which defects occurred are included in the reference profile. It is also possible to include details regarding what kind of defects are involved in each case. Such information concerning the defects is designated here generally as parameters.

The defects can be detected by online analysis methods, for example. If defects that can be ascertained optically are involved, it is also conceivable that they can be recognized directly in the scanning signal, and so a further analysis method can be dispensed with. Scratches on an otherwise planar surface generate a clearly recognizable signal, for example, during the scanning with electromagnetic radiation according to the invention.

The defect is intended to be found again at a later point in time, for example in order to eliminate it. A section of the object in which the defect occurs is determined on the basis of the reference signal. This section of the object is once again scanned in order to generate a local profile. By comparing the local profile with the section of the reference signal which has the defect, it is possible to check whether the correct section of the object is present.

This comparison corresponds to a verification; a check is made to establish whether the section identified in the reference profile and having a specific feature (defect) is actually present where it is indicated by the reference profile.

As a rule, the comparison between the local profile and the identified section of the reference profile reveals that the previously determined location that should have a specific feature does also really lie in the region for which a local profile was created. Therefore, if the determined location having a specific feature was actually localized on the object, then further steps can follow, such as the elimination of defects, for example.

If it emerges during the assignment between local profile and reference profile that the local profile does not comprise the determined location that ought to have a specific feature, it is possible, by means of the assignment, to find the error in the determination of the location and once again to determine the correct region that should have the specific feature.

In another application, the second phase can be used for example to assign, in a divided object, a segment to the corresponding section of the undivided object. The undivided object corresponds to the unprocessed object mentioned above; the divided object corresponds to the processed object mentioned above.

The terms “unprocessed” and “processed” are intended to mean that the object has been subjected to some processing, which need not necessarily lead to a change in the object, between the registration in the first phase (unprocessed state) and the renewed scanning in the second phase. The processing can therefore also be storage, for example. However, the processing is usually a process when the object has been subjected to a change.

In the first phase, a reference profile with respect to the undivided object is created. The object is then divided into a plurality of segments. A segment for assignment is then present for the second phase. Said segment is scanned in order to create a local profile. The local profile is compared section by section with the reference profile in order to be able to assign the local profile to a section of the reference profile. The assignment determines where the segment was previously situated in the undivided counterpart.

Further applications are conceivable.

The invention with the registration in the first phase and the different variants in the second phase can be combined to form the following overall method, which is likewise the subject matter of the present invention:

Method for recognizing and/or finding again a section of an object, comprising the phases of
detecting the object, characterized by the steps of
   scanning a first region of the object with electromagnetic radiation and capturing part of the electromagnetic radiation returned from the object in order to generate a scanning signal,
   generating a reference profile from the scanning signal and storing the reference profile in a database,
identifying a section of the object, characterized by the steps of
   scanning a second region of the object with electromagnetic radiation and capturing part of the electromagnetic radiation returned from the object in order to generate a scanning signal,
   generating a local profile from the scanning signal,
   assigning the local profile to a section of the reference profile,
when the electromagnetic radiation during detecting and identifying has a linear beam profile.

The scanning of a region of the object is preferably effected in the same way in the two phases, in order to achieve a high reproducibility. The region scanned in the first phase is also designated here as first region, and the region scanned in the second phase is also designated here as second region.

The second region usually lies within the first region or at least partly overlaps the latter, in order that an assignment between local profile and a section of the reference profile is actually possible.

Section of the reference profile is understood to be a continuous part of the reference profile that is smaller than the reference profile itself.

During scanning, electromagnetic radiation is incident on the object. During scanning, the incident radiation and the object move relative to one another, such that the electromagnetic radiation sweeps over a region of the object. This sweeping process is also designated here as a scan. The relative movement between object and incident beam can be performed such that the object moves and the radiation source is kept stationary, or performed such that the radiation source moves and the object is kept stationary. It is also conceivable for both the object and the radiation source to move. It is also conceivable for object and radiation source to be kept stationary and for the scanning beam to be guided over a region of the object with the aid of movable mirrors, for example.

The relative movement can be effected continuously with constant speed, in an accelerating manner or in a decelerating manner, or discontinuously, that is to say e.g. in a stepwise manner. The movement is preferably effected with constant speed.

The scanning is effected with electromagnetic radiation. The wavelength of the electromagnetic radiation used depends on the intrinsic structural properties of the object that are present in each case. Depending on the type of intrinsic structural properties, a specific wavelength range can be advantageous because it leads to particularly strong signals, for example. It is conceivable to determine the optimum wavelength range empirically. Visible to infrared light is usually used.

The electromagnetic radiation used can be coherent or incoherent, depending on whether interference phenomena, such as, for example, speckle patterns are useful or disturbing for generating a reference profile. Here, too, the intrinsic structural properties of the object which are intended to generate a characteristic signal upon irradiation are once again crucial for the selection of the properties of the radiation used. The selection is preferably made empirically.

The radiation source used is usually a laser, which can be speckle-reduced as necessary, or an incoherent radiation source such as, for example, an LED (LED=light emitting diode). Methods for reducing speckle phenomena in coherent radiation are known to the person skilled in the art (see e.g. DE102004062418B4). It is also conceivable to use LED arrays, that is to say an arrangement of a plurality of LEDs.

During the irradiation of a region of the object, an interaction occurs between the incident radiation and the object, to put it more precisely the intrinsic structure of the object. The result of said interaction is a characteristic radiation which proceeds from the object and which carries information about the intrinsic structure. This is at least partly captured. Depending on the type of object, the characteristic radiation proceeding from the object is captured in reflection or transmission. It is also conceivable for the capture to take place in reflection and transmission.

Since most objects are non-transparent to electromagnetic radiation in a wide wavelength range, the characteristic radiation proceeding from the object is usually captured in reflection. For simplification, only the reflection variant will be explained in greater detail in the present description. However, the method according to the invention is not restricted to the capture of radiation in reflection, but also encompasses the capture of radiation in transmission. The person skilled in the art of optics knows how the method described in greater detail here has to be modified to capture radiation in transmission.

Preferably, the surface of the object is scanned with the aid of a focussed laser beam. The beam is focussed onto the surface by means of a lens, for example.

If the beam were focussed to a point and this point were guided over the surface of the object in order to generate a reference profile in the first phase, then the region scanned by the point in the first phase would have to be found again in the second phase, which, as should be immediately apparent, is very difficult on account of the small extent of the scanned region.

In this case, it would be advantageous to make the scanned region particularly narrow. The narrower the region, then the faster scanning can take place, the smaller the quantities of data obtained as scanning signal or reference profile, and the shorter the computation time for the assignment in phase 2. On the other hand, as the width decreases it becomes increasingly difficult actually to impinge on this region during scanning in phase 2.

One obvious solution would be to perform, instead of an individual scan, a plurality of adjacent scans and to generate a reference profile therefrom.

According to the invention, however, a linear beam profile is used for scanning, wherein the beam profile is expanded transversely with respect to the scanning direction. As a result, during an individual scan the beam sweeps over a larger region than when a punctiform beam profile is used, and this larger region can later be impinged on again correspondingly more easily and be at least partly scanned once again.

The scanning with a linear beam profile corresponds virtually to an averaging over a multiplicity of scanning signals which result from the scanning with a punctiform beam profile along a multiplicity of closely adjacent lines running parallel. It is surprising that from this averaging over a wide region it is possible to generate a reference profile which is characteristic of individual sections of the object such that the individual sections can unambiguously be found again later.

The use of the linear beam profile makes it possible to register the object rapidly and simply during the detection of phase 1.

Beam profile or is understood to mean the intensity profile of the beam focussed onto the object in cross section in the focal plane.

A linear beam profile is defined here as follows: usually, the intensity is highest in the cross-sectional centre of the radiation and decreases outwards. The intensity can decrease uniformly in all directions—a round cross-sectional profile is present in this case. In all other cases there is at least one direction in which the intensity gradient is the greatest and at least one direction in which the intensity gradient is the smallest. Hereinafter, the beam width is understood to mean that distance from the centre of the cross-sectional profile in the direction of the smallest intensity gradient at which the intensity has fallen to half of its value at the centre. Furthermore, the beam thickness is understood to mean that distance from the centre of the cross-sectional profile in the direction of the highest intensity gradient at which the intensity has fallen to half of its value in the centre. A linear beam profile is designated as a beam profile in which the beam width is greater than the beam thickness by a factor of more than 10. Preferably, the beam width is greater than the beam thickness by a factor of more than 50, particularly preferably by a factor of more than 100, and especially preferably by a factor of more than 150.

In one preferred embodiment, the beam thickness is in the range of the average groove width of the surface present (for the definition of the average groove width, see DIN EN ISO 4287:1998).

For a large number of objects, in particular for objects composed of paper, the following beam thicknesses and widths have proved to be suitable:
Beam widths in the range of 2 mm to 7 mm, preferably in the range of 3 mm to 6.5 mm, particularly preferably in the range of 4 mm to 6 mm, and especially particularly preferably in the range of 4.5 mm to 5.5 mm.
Beam thicknesses in the range of 5 μm to 35 μm, preferably in the range of 10 μm to 30 μm, particularly preferably in the range of 15 μm to 30 μm, especially preferably in the range of 20 μm to 27 μm.

The person skilled in the art of optics knows how a corresponding beam profile can be generated by means of optical elements. Optical elements serve for beam shaping and focussing. In particular lenses, stops, diffractive optical elements and the like are designated as optical elements.

It has surprisingly been found that the abovementioned ranges for the beam thickness and the beam width are very well suited to achieving, on the one hand, the positioning accurate enough for reproducibility and, on the other hand, to achieving a a signal-to-noise ratio sufficient for a sufficiently accurate assignment of the local profile to a section of the reference profile.

The characteristic radiation proceeding from the object is captured with the aid of one or more detectors. Customary detectors are camera, photodiodes or a phototransistor.

The radiation source, the object and one or more detectors can be arranged in various ways with respect to one another. Usually, the intrinsic structural properties of the object determine the optimum arrangement. Two preferred arrangements will be discussed in greater detail below, without the invention being restricted thereto.

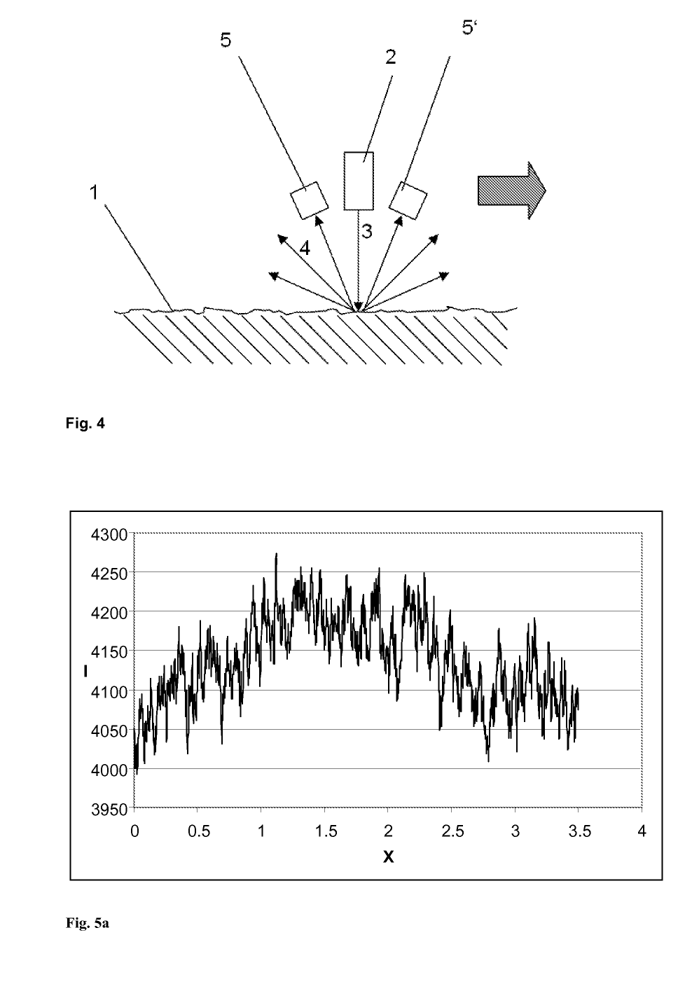

In the case of objects which generate a high proportion of diffusely reflected radiation upon irradiation with electromagnetic radiation, the scanning beam is incident on the surface of the object preferably perpendicularly (FIG. 4). One or more detectors are preferably arranged laterally with respect to the scanning beam in order to capture diffusely reflected (scattered) radiation. A corresponding sensor which can be used to carry out this embodiment of the method according to the invention is described for example in the publication WO2010/118835(A1) or the application document DE102010015014.2, the content of which shall be incorporated by reference in this description.

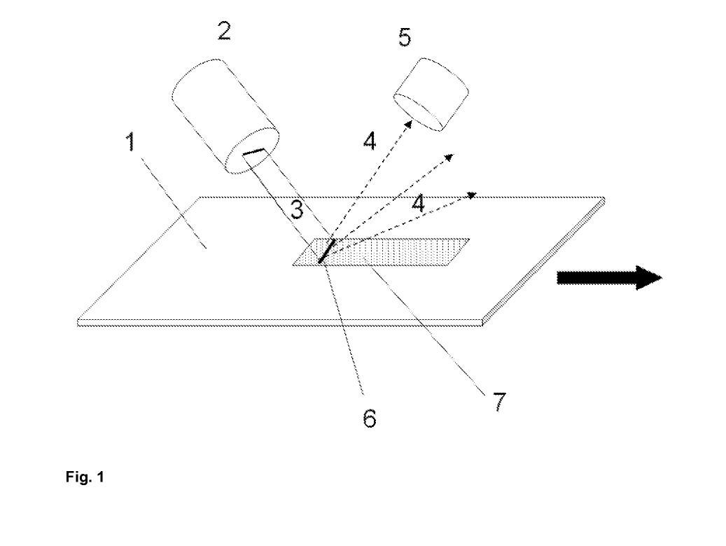

In the case of objects which generate a high proportion of specularly reflected radiation upon irradiation with electromagnetic radiation, the scanning beam is incident on the object preferably obliquely, that is to say at an angle of incidence in the range of 10° to 80°, particularly preferably in the range of 20° to 70°, and especially preferably in the range of 30° to 60°, relative to the normal to the surface of said object. Specularly reflected radiation is returned from the object at an angle of reflection corresponding to the angle of incidence, in accordance with the reflection law. One or more detectors are preferably arranged laterally with respect to the angle of reflection in an angular range of 5° to 30° relative to the angle of reflection (FIG. 1). A corresponding sensor which can be used to carry out this embodiment of the method according to the invention is described for example in the publication WO2010/040422(A1) or the application document DE102009059054.4, the content of which shall be incorporated by reference in this description.

With the aid of the detector, a signal, which is also designated here as scanning signal, is generated from the captured radiation. Finally, a reference profile or a local profile is generated from the scanning signal.

The process of irradiating a region of the object with relative movement of the object and the beam impinging on the object and with capture of part of the characteristic radiation proceeding from the object on account of the irradiation is designed here in summary as scanning.

As described above, the relative movement between object and scanning beam can be effected in a constant fashion or discontinuously. Usually, the radiation arriving at the detector during scanning is detected with a discrete and constant scanning frequency and digitized. The scanning signal is thus usually an intensity-time function. If a region of the object is scanned with constant speed, there is a linear relationship between the time of capturing an intensity value and the location of the object at which the respective intensity value occurred during irradiation, such that an intensity-location function can be calculated from the intensity-time function in a simple manner. If the relative movement between object and scanning signal is not constant, a correspondingly more complex relationship arises between intensity-time function and intensity-location function. In any case a transformation function has to be known for converting the intensity-time function into an intensity-location function. Here it is possible to have recourse to the coding methods known from the prior art.

It is conceivable, for example, to use a mechanical, optical or magnetic coder for determining the transformation function. In the case of WO05/088533A1, by way of example, markings having a uniform spacing of 300 micrometers are used for transforming the intensity-time signal into an intensity-location signal (see WO05/088533A1, page 23). These markings are optically detected by means of a separate photodetector. Since the constant measuring frequency (scanning) and the spacing of the markings are known, the location at which the focussed scanning beam was situated can be determined at every point in time. It is thus possible to transform the time-dependent scanning signal into a time-independent intensity-location signal with the aid of the coder.

In the case of some objects, no markings need be applied, since they have a constant undulation that can be used for correlation between location and time (see e.g. the application document DE 102010021380.2).

It is likewise conceivable to track the relative movement between object and scanning signal by means of speckle velocimetry methods (see e.g. EP0947833B1) or analogous methods.

A further possibility for determining a transformation function is described in the application document DE102010020810.8, the content of which shall be incorporated by reference in this description.

As a rule, the reference profile and the local profile are generated from the scanning signal by various mathematical methods such as filtering and/or background extraction or other other methods of signal processing. These mathematical methods eliminate to the greatest possible extent for example random or systematic fluctuations resulting from individual measurements.

As described above, parameters concerning individual sections of the object are included in the reference profile. It is also conceivable to include further information concerning the object in the reference profile, such as, for example, batch numbers, identification numbers, images, property parameters and many more.

The reference profile is stored in a database in order to be able to have recourse to it at a later point in time (in the second phase), wherein the term database should generally be understood as data or information store.

Storage can be effected for example on an electronic storage medium (semiconductor memory), an optical storage medium (e.g. compact disc), a magnetic storage medium (e.g. hard disk) or some other medium for storing information. It is also conceivable to store the signature as an optical code (barcode, matrix code) on a paper or the object itself or as a hologram.

Once the reference profile has been generated and stored, the respective object has been registered.

At a later point in time, the object is once again scanned. Usually, a smaller region is scanned in the second phase than in the first phase.

During the assignment of local profile to reference profile, the local profile is compared with one or more sections of the reference profile in order to identify that section of the reference profile which is the most similar to the local profile, or in order to verify that a local profile is identical to a predefined section of the reference profile.

The comparison itself can be effected using mathematical methods that are sufficiently known to the person skilled in the art. By way of example, it is possible to use known methods of pattern matching which search for similarities between data sets (see e.g. Image Analysis and Processing: 8th International Conference, ICIAP '95, San Remo, Italy, Sep. 13-15, 1995. Proceedings (Lecture Notes in Computer Science), WO 2005088533(A1), WO2006016114(A1), C. Demant, B. Streicher-Abel, P. Waszkewitz, Industrielle Bildverarbeitung [Industrial Image Processing], Springer-Verlag, 1998, page 133 et seq., J. Rosenbaum, Barcode, Verlag Technik Berlin, 2000, page 84 et seq., U.S. Pat. No. 7,333,641 B2, DE10260642 A1, DE10260638 A1, EP1435586B1). Optical correlation methods are also conceivable.

A computer is usually used for the generation of reference profile and/or local profile and for the assignment and for the comparison of profiles and/or profile sections. The result of an assignment and/or of a comparison is usually displayed to a user on a screen. It is also conceivable for the result to be transferred to a machine for further processing of the object. These and further possibilities are well known to the person skilled in the art of automation technology.

The invention is explained in greater detail below with reference to figures, without being restricted to the embodiments shown therein.

FIG. 1 schematically shows the method according to the invention for scanning the surface 1 of an object. A region 7 of the surface 1 is irradiated by means of a source 2 of electromagnetic radiation. Part of the reflected radiation 4 is captured with the aid of a detector 5 in order to record a scanning signal. The object is moved in relation to the arrangement of radiation source 2 and 5 detector (represented by the thick black arrow). A linear beam profile 6 is present in the surface plane, the longer extent of said beam profile being situated transversely with respect to the direction of movement.

Subfigures 2(a) and 2(b) illustrate a linear beam profile having a beam width SB and a beam thickness SD. Subfigure 2(a) illustrates the two-dimensional cross-sectional profile of an electromagnetic beam at the focal point. The highest intensity I is present in the centre of the cross-sectional profile. The intensity I decreases outwards, in which case there is a first direction (x), in which the intensity I decreases to the greatest extent with increasing distance A from the centre, and a further direction (y), which is perpendicular to the first direction (x), in which the intensity I decreases to the weakest extent with increasing distance A from the centre. Subfigure 2(b) shows the intensity profile/as a function of the distance A from the centre. The beam width and the beam thickness are defined as those distances from the centre at which the intensity I has fallen to 50% of its maximum value in the centre, here the beam width lying in the y-direction and the beam thickness in x-direction.

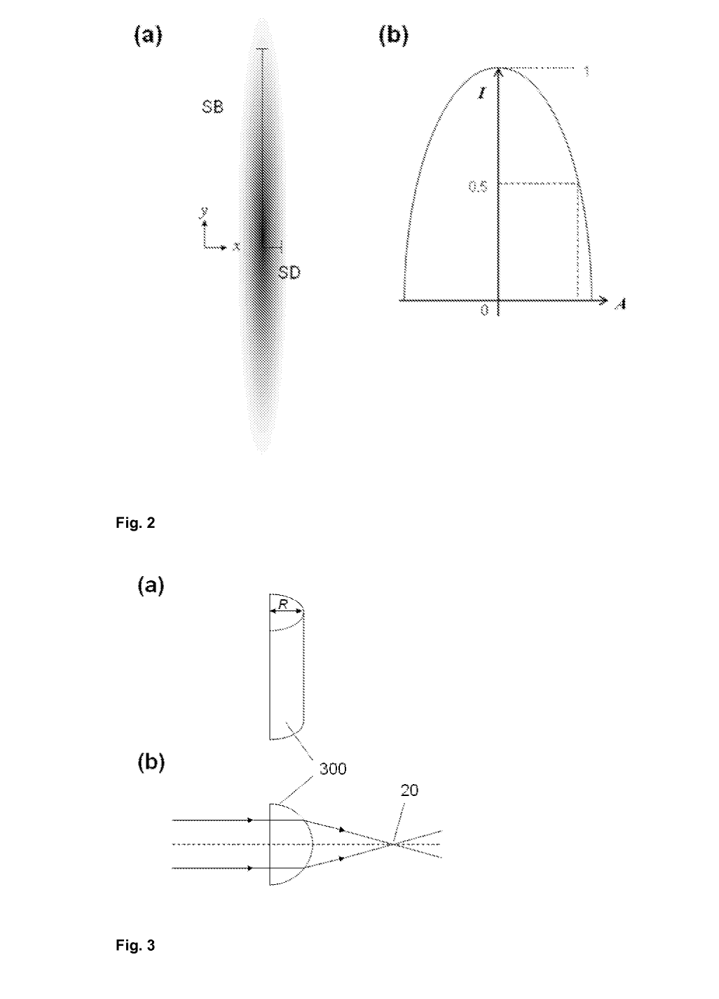

Subfigures 3(a) and 3(b) show by way of example how a linear beam profile can be generated with the aid of a planoconvex cylindrical lens 300. The cylindrical lens 300 acts as a converging lens in one plane (FIG. 3(b)). It has no refractive effect in the plane perpendicular thereto. In the paraxial approximation, the following formula holds true for the focal length f of such a lens:

$$f = \frac{R}{n - 1} \qquad Equ . 1$$

where R is the cylinder radius and n is the refractive index of the lens material.

FIG. 4 shows one preferred arrangement for scanning an object, wherein scanning beam 3 is incidental on the surface of the object perpendicularly. Two detectors 5, 5′ are arranged laterally with respect to the radiation source 2, said detectors capturing diffusely reflected radiation 4.

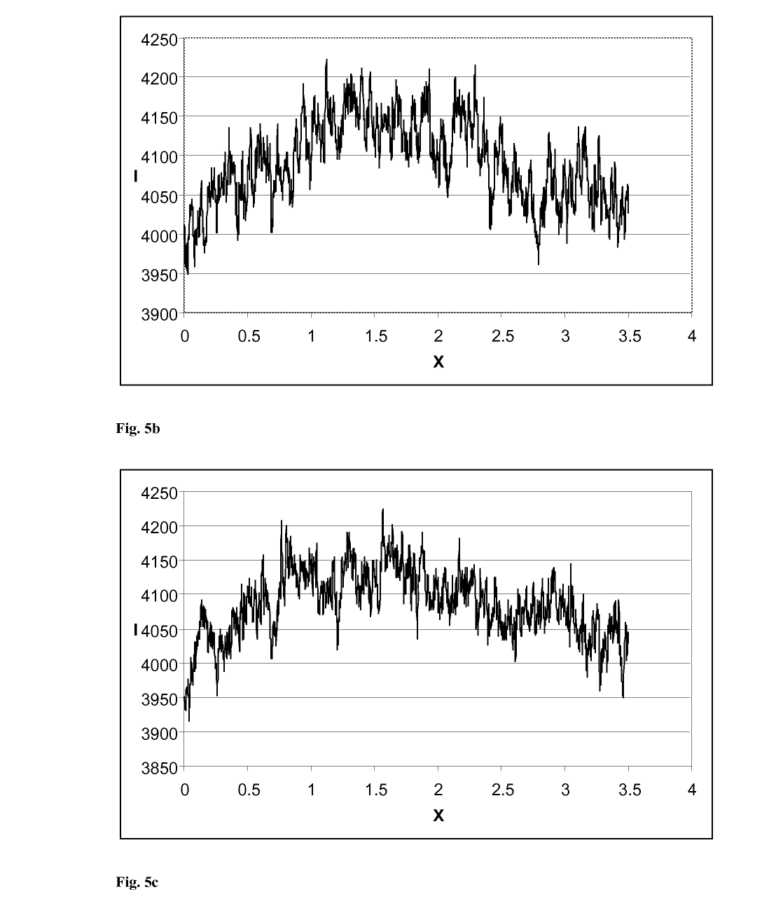

FIGS. 5a, 5b and 5c show scanning signals that result from the scanning of an object with a linear beam profile. The scanning signal was recorded in each case by means of a sensor in accordance with application document DE102009059054.4, FIG. 3. The ordinate in each case shows the voltage signal I (in arbitrary units) of the photodetector used, said signal being proportional to the intensity of the incident radiation. The distance X in cm covered during the scanning along a single line is plotted on the abscissa. A single photodetector in the second leadthrough (12) was used in all three cases. The scanned object was a composite material consisting of the spacial paper 7110 from 3M (3M 7110 litho paper, white) and laminated thereon a protective film PET Overlam RP35 from UPM Raflatac. The radiation source used was a speckle-reduced laser diode (Flexpoint line module FP-HOM-SLD, Laser Components GmbH). The beam profile was linear, having a beam width of 5 mm and a beam thickness of 25 μm.

The same region was scanned in the case of FIGS. 5a and 5b. The signals are very similar. A different region from that in the cases of FIGS. 5a and 5b was scanned in the case of FIG. 5c. The signal in FIG. 5c clearly differs from the signals in FIGS. 5a and 5b. A comparison of the signals from FIGS. 5a and 5b produced a correlation coefficient of 0.98, while the comparison of the signals from FIGS. 5a and 5c yielded a correlation coefficient of 0.6. The scanning signals could still be reproduced very well even after a relatively long time.

The scanning signals in FIGS. 5a, 5b and 5c have a multiplicity of characteristic features that make it possible to recognize a section of the object again.

The scanning signals can be stored directly as reference profiles.

### REFERENCE SIGNS

1 Surface
2 Source of electromagnetic radiation
3 Scanning beam
4 Reflected radiation
5 Detector for electromagnetic radiation
5′ Detector for electromagnetic radiation
6 Linear beam profile
7 Scanning region
20 Focal point
300 Cylindrical lens

1. Method for registering an object, comprising scanning a region of the object with electromagnetic radiation and at least part of the electromagnetic radiation emitted from the object on account of the scanning is captured and the scanning signal obtained, if appropriate after signal processing is stored together with further parameters concerning individual sections of the object in the form of a reference profile in a database, wherein the electromagnetic radiation used for scanning has a linear beam profile.

2. Method for recognizing and/or finding again a section of an object, comprising:
determining, on the basis of the reference profile with respect to the object, in which section of the object a predefined parameter is present,
scanning the determined section with electromagnetic radiation, capturing at least part of the electromagnetic radiation emitted from the object on account of the scanning, and generating a local profile from the scanning signal obtained, if appropriate using signal processing methods, wherein the electromagnetic radiation used for scanning has a linear beam profile,
comparing the local profile with that part of the reference profile which corresponds to the determined section.

3. Method for assigning a section of a processed object to a corresponding section of an unprocessed object, comprising:
scanning a section of the processed object with electromagnetic radiation, capturing at least part of the electromagnetic radiation emitted from the processed object on account of the scanning, and generating a local profile from the scanning signal obtained, if appropriate using signal processing methods, wherein the electromagnetic radiation used for scanning has a linear beam profile,
comparing, section by section, the local profile with a reference profile of the unprocessed object and identifying a section of the reference profile which has greatest similarity to the local profile.

4. Method according to claim 1, wherein the beam width of the linear beam profile is greater than the beam thickness by a factor of at least 50.

5. Method according to claim 1, wherein the beam width is in the range of 2 mm to 7 mm, optionally in the range of 3 mm to 6.5 mm, or optionally in the range of 4 mm to 6 mm, and/or optionally in the range of 4.5 mm to 5.5 mm, while the beam thickness is in the range of 5 μm to 35 μm, or optionally in the range of 10 μm to 30 μm, or optionally in the range of 15 μm to 30 μm, or optionally in the range of 20 μm to 27 μm.

6. Method according to claim 1, wherein electromagnetic radiation having a wavelength in the range of visible to infrared light is used for scanning.

7. Method according to claim 1, wherein a scanning beam is incident on a surface of the object perpendicularly and radiation diffusely reflected from the surface is captured laterally with respect to a scanning beam.

8. Method according to claim 1, wherein a scanning beam is incident on a surface of the object obliquely and one or more detectors for capturing returned radiation are mounted laterally with respect to a specularly reflected beam.

9. A method for recognizing and/or finding again a section of an object, comprising:
a) scanning a region of the object with electromagnetic radiation and capturing and, if appropriate after signal processing, storing in a database at least part of the electromagnetic radiation emitted from the object on account of the scanning together with further parameters concerning individual sections of the object in the form of a reference profile, wherein the electromagnetic radiation used for scanning comprises a linear beam profile, and a reference profile comprises information concerning intrinsic structural properties of the object and positions of the object at which intrinsic structural properties occur,
b) determining, on the basis of the reference profile with respect to the object, in which section of the object a predefined parameter is present,
c) for the purpose of finding again said section in accordance with b) in which the predefined parameter is present, once again scanning the determined section with electromagnetic radiation, capturing at least part of the electromagnetic radiation emitted from the object on account of the scanning, and generating a local profile from the scanning signal obtained, if appropriate using signal processing methods, wherein the electromagnetic radiation used for scanning has a linear beam profile,
d) comparing the local profile with that part of the reference profile which corresponds to the determined section according to b)
e) recognizing the section according to b).

10. The method according to claim 9, wherein a beam width of the linear beam profile is greater than beam thickness by a factor of at least 50.

11. The method according to claim 9, wherein the beam width is in the range of from 2 mm to 7 mm, optionally in the range of from 3 mm to 6.5 mm, while the beam thickness is in the range of from 5 μm to 35 μm, and optionally in the range of from 10 μm to 30 μm.

12. The method according to claim 9, wherein electromagnetic radiation comprising a wavelength in the range of visible to infrared light is used for scanning.

13. The method according to claim 9, wherein a scanning beam is incident on a surface of the object perpendicularly and radiation diffusely reflected from the surface is captured laterally with respect to the scanning beam.

14. The method according to claim 9, wherein a scanning beam is incident on a surface of the object obliquely and one or more detectors for capturing returned radiation are mounted laterally with respect to a specularly reflected beam.
